(19) United States
(12) Patent Application Publication
(10) Pub. No.: US 2003/0051745 A1
(43) Pub. Date: Mar. 20, 2003

(54) Substrate aspiration assembly

(76) Inventor: Larry Myland, West Chester, PA (US)

Correspondence Address: COZEN AND O'CONNOR, 1900 MARKET STREET, PHILADELPHIA, PA, 19103, US

(21) Appl. No.: 10/005,690

(22) Filed: Nov. 8, 2001

Related U.S. Application Data
(60) Provisional application No. 60/275,933, filed on Mar. 15, 2001.

(51) Int. Cl. B08B 3/00; B08B 7/00

(52) U.S. Cl. 134/95.2; 134/99.1; 134/7; 134/21

(57) ABSTRACT

An apparatus is disclosed for drying wafer substrates in a process tank having an object supporting member for supporting one or more wafer substrates, the object supporting member having apertures through which “vacuum force” can be applied to essentially remove trace amounts of liquid from object contact points formed by the support of the wafer substrate by the object supporting member. Also disclosed is a method of implementing the disclosed apparatus comprising transferring a wafer substrate from an object transporting member to the object supporting member, providing an aperture at or near each contact point, and applying a “vacuum force” through the apertures to remove any trace amounts of liquid. Also disclosed and claimed are wafer substrates resulting from application of the disclosed drying process and apparatus.

### CROSS-REFERENCE TO RELATED APPLICATIONS

This application claims the benefit of Provisional Application No. 60/275,933 filed Mar. 15, 2001.

### BACKGROUND OF THE INVENTION

The present invention relates to apparatus and processes for drying substrates, especially silicon wafer substrates, flat panel display substrates, and other types of substrates which must be cleaned, rinsed, and dried during the manufacture of an object. The invention especially relates to removing trace amounts of water from silicon wafer substrates in a process tank during the manufacture of integrated circuits.

Many systems and methods have been devised to dry objects. With certain types of objects, such as silicon wafers and flat panel displays where high yields are desired, very sophisticated systems and methods have been devised to dry the object as quickly and as completely as possible.

For example, in the field of manufacture of semiconductors and integrated circuits from silicon wafers, hundreds of circuits can be made from each wafer substrate by process which require many cycles of cleaning, rinsing, and drying.

Due to deficiencies of prior art systems and methods of drying substrates, it is impossible to completely remove all traces of liquid from the points where the drying apparatus contacts the edges of the substrates. For example, in process tanks where a supporting member is used to lift a substrate off of a transporting member so that most of the water can drain from the substrate, it is a well recognized problem in the art to quickly and effectively remove traces of water from the contact points. Therefore, there is a certain very valuable portion of the substrate which is wasted due to what is known in the art as “edge exclusion,” a term referring to the portion near the edges which cannot be completely dried and must be discarded.

There have been many attempts by others to improve dryer systems and drying methods so as to eliminate the need for edge exclusion by completely drying the wafer substrate. However, none have fully solved the problem of water residue at edge contact points.

For example, Mohindra, et al., U.S. Pat. No. 5,571,337, teach pulsing a drying fluid such as nitrogen gas directed at the edge of the partially completed semiconductor to remove the liquid from the edge. Application of the Mohindra et al process results in evaporation of the liquid at the contact points. Evaporation is undesirable because particles and water spots are left behind, both of which decrease yields. McConnell, et al., U.S. Pat. No. 4,984,597, teach using large amount of IPA to replace water and enhance drying. Such process requires special tanks and elaborate support equipment.

Many other systems and methods have been proposed to try to solve the edge exclusion problem resulting from inability to efficiently remove water residue from the contact points between the edges of objects and the supporting members of dryers in a clean, low cost, or timely manner, but none have completely solved the problem.

### SUMMARY OF THE INVENTION

It is therefore an objective of the present invention to eliminate water residue at the edges of objects for the drying thereof.

Another objective of the invention is to provide a quicker method of drying high value objects.

A further objective is to eliminate defects at the contact points between dryer equipment and the object being dried.

A still further objective is to improve yields of high value integrated circuits from silicon wafers.

Additional objects, advantages and other novel features of the invention will be set forth in part in the description that follows and in part will become apparent to those skilled in the art upon examination of the following or may be learned with the practice of the invention. The objects and advantages of the invention may be realized and obtained by means of the instrumentalities and combinations particularly pointed out in the claims.

To achieve the foregoing and other objects, the invention comprises three aspects, a system for drying objects, a method for drying objects, and the resultant dried object produced by implementing a particular drying method.

System For Drying Objects

In one aspect, the invention is a system for use in drying objects in a process tank. The system comprising an object supporting member having at least one contact point for each object supported, at least one aperture at or near each contact point, and a source of negative pressure fluidly connected to each aperture.

Preferably, the object supporting means is adapted to support a plurality of wafer substrates and the objects to be dried are wafer substrates. Also, the source of negative pressure is preferably one or more vacuum or eductor pumps.

In one embodiment of the system of invention, the object supporting member is in a fixed position at or near the bottom of the process tank. The system further includes an object transporting member for delivering the object to the fixed object supporting member, the object transporting member preferably being a wafer basket. The wafer basket is adapted to carry a plurality of wafer substrates. In this embodiment of the system, the object supporting member has two outside lifters, a center lifter, and a base plate. The outside lifters and center lifter extend upward from the base plate and the center lifter is shorter than the outside lifters. The outside lifters and center lifter are so positioned on the base plate so that wafer substrates in a wafer basket can be engaged, removed from the wafer basket, and supported by the object supporting member. For each wafer supported by the object supporting member, three contact points are formed. Each contact point is located at or near at least one aperture which is fluidly connected to the one or more eductor pumps.

In another embodiment of the system of invention, the object supporting member is movable between a loading position at or near the top of the process tank and a position at or near the bottom of the process tank. The object supporting member remains fluidly connected to the one or more vacuum or eductor pumps over the entire range of motion. Such fluid connection is made possible by means of flexible vacuum tubing. Preferably, the object supporting member has two side support tubes and a bottom support tube. When a wafer substrate is loaded into the object supporting member, three contact points are formed for each wafer substrate supported. Each contact point is located at or near at least one aperture which is fluidly connected to the one or more eductor pumps.

Method of Drying Objects

In another aspect, the invention is a method of drying objects in a process tank having an object supporting member having at least one contact point for each object supported and an object transporting member. The process comprising the steps of providing at least one aperture at or near each contact point of the object supporting member and a source of negative pressure fluidly connected to each aperture, filling the process tank with a liquid, transferring the objects from the object transporting member to the object supporting member, applying a vacuum force through the apertures so as to essentially remove trace amounts of liquid from each contact point, draining the liquid from the process tank so as to substantially dry the objects, and transferring the resultant fully dried objects from the object supporting member to the object transporting member.

Preferably, the object transporting member is a wafer basket and the objects to be dried are wafer substrates. The wafer basket is adapted to carry a plurality of wafer substrates and the object supporting member is adapted to support the plurality of wafer substrates. Also preferably, the source of negative pressure is one or more vacuum or eductor pumps.

In one embodiment of the method of invention, the object supporting member is in a fixed position at or near the bottom of the process tank. The object supporting member has two outside lifters, a center lifter, and a base plate. The outside lifters and center lifter extend upward from the base plate and the center lifter is shorter than the outside lifters. The outside lifters and center lifter are so positioned on the base plate so that wafer substrates that are in a wafer basket can be engaged, removed from the wafer basket, and supported by the object supporting member. For each wafer supported by the object supporting member, three contact points are formed with the object supporting member. Each contact point is located at or near at least one aperture which is fluidly connected to the one or more vacuum or eductor pumps.

In this embodiment of the method of invention, the process tank is filled with DI water. The wafer basket, which has one or more wafer substrates contained therein, is lowered into the process tank, submersing the wafer substrates in the DI water. The wafer basket is lowered until the wafer substrates are contacted by the object supporting member, removed from the wafer basket, and supported solely by the object supporting member. The process tank is then sealed. The remaining volume of the process tank is then pumped full of nitrogen gas and some liquid IPA forming a nitrogen-IPA vapor in the process tank. The DI water is drained from the process tank by opening a slow drain valve located at or near the bottom of the process tank. When the slow drain valve is opened, the vacuum or eductor pumps are also activated, creating a vacuum force at all of the apertures on the object supporting member. The DI water continues to drain from the process tank while nitrogen-IPA vapor continues to form in the process tank. When the DI water level gets to a level just below the apertures located on the outside lifters of the object supporting member, the vacuum force for those apertures is discontinued. The DI water continues to be drained from the tank until it reaches a point at or below the wafer substrates. At this point, large piston valves are actuated to an open position thus quickly draining the remaining liquids. The IPA liquid flow is then discontinued and pure nitrogen gas continues to be pumped into the tank. The vacuum force of the apertures on the center lifter of the object supporting member is discontinued. The resultant fully dried wafer substrates are then transferred from the object supporting member to the wafer basket by raising the wafer basket. The loaded wafer basket is then removed from the tank.

In another embodiment of the method of invention, the object supporting member is movable between a loading position at or near the top of the process tank and a position at or near the bottom of the process tank. The object supporting member remains fluidly connected to the one or more vacuum or eductor pumps over the entire range of motion. Such fluid connection is made possible by means of flexible vacuum tubing. In this embodiment, the object supporting member has two side support tubes and a bottom support tube. When a wafer substrate is loaded into the object supporting member, three contact points are formed with the object supporting member for each wafer substrate. Each of these contact points are located at or near at least one aperture which is fluidly connected to the one or more vacuum or eductor pumps.

In this embodiment of the method of invention, the process tank is filled with DI water. The object supporting member is moved to the loading position at or near the top of the process tank. The wafers are then transferred from an active gripper to the object supporting member. The object supporting member, which has one or more wafer substrates contained therein, is then lowered into the process tank, submersing the wafer substrates in the DI water. The object supporting member is continued to be lowered until it reaches a position at or near the bottom of the process tank. The process tank is sealed. The remaining volume of the process tank is pumped full of nitrogen gas and some liquid IPA forming a nitrogen-IPA vapor in the process tank. The DI water is drained from the process tank by opening a slow drain valve located at or near the bottom of the process tank. When the slow drain valve is opened, the vacuum or eductor pumps are also activated, creating a vacuum force at all of the apertures on the object supporting member. The DI water continues to drain from the process tank while nitrogen-IPA vapor continues to be formed in the process tank. When the DI water level gets to a level just below the apertures located on the two side support tubes of the object supporting member, the vacuum force for those apertures is discontinued. The DI water continues to be drained until it reaches a point at or below the wafer substrates, large piston valves are then actuated to an open position thus quickly draining the remaining liquids. At this point, the IPA liquid flow is discontinued and pure nitrogen gas continues to be pumped into the tank. The vacuum force of the apertures on the bottom support tube of the object supporting member is discontinued. The object supporting member then raises the resultant fully dried wafer substrates from the position at or near the bottom of the process tank to the loading position at or near the top of the process tank. The wafer substrates are then transferred from the object supporting member to the active gripper.

The Objects Produced

In yet another aspect, the invention is a wafer substrate dried in a process tank having an object supporting member having at least one contact point for each wafer substrate supported and an object transporting member. The wafer substrate being dried by a drying process comprising the steps of providing at least one aperture at or near each contact point of the object supporting member and a source of negative pressure fluidly connected to each aperture, filling the process tank with a liquid, transferring the objects from the object transporting member to the object supporting member, applying a vacuum force through the apertures so as to essentially remove trace amounts of liquid from each contact point, draining the liquid from the process tank so as to substantially clean then dry the objects, and transferring the resultant fully dried objects from the object supporting member to the object transporting member.

### BRIEF DESCRIPTION OF THE DRAWINGS

FIG. 1 is a side elevational view of an object transporting member, illustrated as a wafer basket, with an object, illustrated as a wafer substrate, being lowered into the object transporting member.

FIG. 2 is a top view of the object transporting member, illustrated as a wafer basket.

FIG. 3 is a side elevational view of a fixed supporting member.

FIG. 4 is a side elevational view of the top portion of an outside lifter of the fixed supporting member.

FIG. 5 is a side view of the outside lifter.

FIG. 6 is a cross-sectional view of the outside lifter taken along line VI-VI in FIG. 5.

FIG. 7 is a bottom view of the outside lifter.

FIG. 8 is a schematic cross-sectional view of a process tank implementing the fixed supporting member.

FIG. 9 is a schematic cross-sectional view of a process tank implementing the fixed supporting member where the object is in an object transporting member and is being lowered into the process tank.

FIG. 10 is a schematic cross-sectional view of a process tank implementing the fixed supporting member where the object transporting member is fully lowered and the object is no longer in contact with the object transporting member, (i.e., is solely supported by the supporting member).

FIG. 11 is a side cross-sectional view of the fixed supporting member in the process tank as it supports the object.

FIG. 12 is a flowchart summarizing the claimed substrate aspiration drying process utilizing the fixed supporting member.

FIG. 13 is a side elevational view of a modified supporting member with an object being slidably inserted therein.

FIG. 14 is a side elevational view of a bottom support tube of the modified supporting member.

FIG. 15 is a cross-sectional view of the modified supporting member with an object, in the form of a wafer substrate, slidably inserted therein.

FIG. 16 is a schematic cross-sectional view of a process tank implementing the modified support member in the fully lowered position.

FIG. 17 is a schematic cross-sectional view of a process tank implementing the modified support member in the fully raised position.

FIG. 18 is a flowchart summarizing the claimed substrate aspiration drying process utilizing a movable supporting member.

### DETAILED DESCRIPTION

The figures depict a preferred embodiment of the present invention for purposes of illustration only. One, skilled in the art will readily recognize from the following discussion that alternative embodiments of the structures and methods illustrated herein may be employed without departing from the principles of the invention described herein.

Referring to FIG. 1, an object transporting member 1 is illustrated in the embodiment of a wafer basket 1. The wafer basket 1 has a front panel 2, a rear panel 3, two side panels 4, two bottom support panels 5, and a plurality of object separating guides 6 protruding from both side panels 4 and bottom support panels 5. The object separating guides 6 are so aligned that a wafer substrate 7 can be slidably placed between and supported by said object separating guides 6.

Referring now to FIG. 2, wafer basket 1 also has two side opening holes 8 and a bottom opening hole 9.

FIG. 3 illustrates a fixed supporting member 10 which is capable of aspiration and includes two outside lifters 11 and a shorter center lifter 12. Both the outside lifters 11 and the center lifter 12 are constructed so as to have a plurality of jagged wafer holding combs 13 along the top portion of each outside lifter 11 and center lifter 12. The jagged wafer holding combs 13 are so aligned on the outside lifters 11 and the center lifter 12 so that a wafer substrate 7 can be slidably inserted between and supported by the outside lifters 11 and the center lifter 12. The fixed supporting member 10 further includes a base plate 14 which has a plurality of drainage holes 15 located throughout the base plate 14 to facilitate the drainage of liquid from the fixed supporting member 10.

Referring to FIG. 4, a view of the center lifter 12 is shown. The top portion of the center lifter 12 has a plurality of vacuum holes 16 located between each of the jagged wafer holding combs 13.

Referring now to FIG. 5, each vacuum hole 16 is the opening of an aspiration channel 17 that is fluidly connected to a vacuum tube 18. All of the aspiration channels 17 are connected to a single vacuum tube 18 that runs through the interior of the outside lifter 11. FIG. 6 is a cross-sectioned view of these features.

Referring to FIG. 7, the vacuum tube 18 of the outside lifter 11 also has a manifold connection hole 19 at the bottom surface of the outside lifter 11.

Outside lifters 11 have characteristics similar to those disclosed in FIGS. 4, 5, 6, 7 as discussed above. Specifically, the top portion of the outside lifters 11 have a plurality of vacuum holes 16 located between each of the jagged wafer holding combs 13. Each vacuum hole 16 of the outside lifters 11 being the opening of an aspiration channel 17 that is fluidly connected to a vacuum tube 18. The vacuum tube 18 of the outside lifters 11 having a manifold connection hole 19 at the bottom surface of the each outside lifter 11.

FIG. 8, illustrates an embodiment of the invention wherein, the fixed supporting member 10 is rigidly connected to a process tank 20 near the bottom of the process tank 20. The manifold connection holes 19 of the outside lifters 11 and the center lifter 12 are fluidly connected to a vacuum system 21 capable of producing negative pressure. The process tank 20 has a tank lid 22, a slow drain valve 23, one or more large piston valves 39, and DI water supply valves 24. A DI water supply system 25 is fluidly connected to the process tank 20 by a DI water supply tube 26. The tank lid 22 has a porous tube 28 connected thereto. The porous tube 28 is fluidly connected to a nitrogen supply tube 29 and a liquid IPA supply tube 30 that are capable of supplying nitrogen and IPA respectively.

Referring to FIG. 9, as the wafer basket 1 containing at least one wafer substrate 7 is lowered into the process tank 20, the wafer basket 1 is so positioned that the outside lifters 11 and the center lifter 12 of the fixed supporting member 10 are respectively aligned with the two side opening holes 8 and bottom opening hole 9 of the wafer basket 1.

Referring now to FIG. 10, when the wafer basket 1 is in the fully lowered position the outside lifters 11 and center lifter 12 respectively extend through the two side opening holes 8 and bottom opening hole 9 of the wafer basket 1, engaging and supporting any wafer substrates 7 that are in the wafer basket 1. The wafer substrates 7 are removed from, and no longer in contact with, any part of the wafer basket 1. At this point, the wafer substrates 7 are captured between corresponding jagged wafer holding combs 13 of the outside lifters 1 1 and center lifter 12 and are solely supported thereby.

Referring now to FIG. 11, when the wafer substrate 7 is captured and supported by the outside lifters 11 and center lifter 12 of the fixed supporting member 10, each wafer substrate 7 is in contact with exactly three points of the fixed supporting member 10, referred to herein as aspiration contact points 31. Each of the three aspiration points 31 for each wafer substrate 7 is at or near a vacuum hole 16 for the corresponding outside lifters 11 and center lifter 12.

FIG. 12 summarizes the above described steps of loading the wafer substrates 7 onto the fixed supporting member 10 and further summarizes the remaining steps performed in practicing the claimed aspiration drying process when utilizing a fixed supporting member 10. At step 100, as discussed in detail above, a wafer basket 1 with at least one wafer substrate 7 therein is lowered into the process tank 20 which is filled with DI water. Thereafter, at step 101, the fixed supporting member 10, which is located near the bottom of the process tank 20, contacts the wafer substrates 7 and fully removes the wafer substrates 7 from the wafer basket 1. Now that the wafer substrates 7 are fully submersed in the DI water and in sole contact with the fixed supporting member 10, the wafer substrates are wet and need to be dried.

At step 102, the tank lid 22 is put in place and the remaining volume of the sealed process tank 20 is filled with nitrogen and liquid IPA through the porous tube 28 which is supplied by the nitrogen supply tube 29 and liquid IPA supply tube 30 respectively. Next, at step 103, the slow drain valve 23 is then opened and the vacuum system 21 is activated. Activating the vacuum system 21 creates a vacuum force at the vacuum holes 16 and sucks DI water into said vacuum holes 16. As the DI water drains from the tank, the nitrogen-IPA vapor takes its place by occupying the volume of the process tank 20 previously occupied by the DI water.

At step 104, once the DI water level is just below the aspiration contact points 31 of the outside lifters 11, the vacuum force for those two aspiration contact points 31 is discontinued. The DI water in the process tank 20 continues to drain as a result of the slow drain valve 23 being open and the vacuum force being applied by the vacuum hole 16 at the aspiration contact point 31 of the center lifter 12. At step 105, when the DI water level gets to a level at or below the wafer substrates, large piston valves 39 are actuated to an open position thus quickly draining the remaining liquids. When the DI water is totally drained from the process tank 20, the tank is completely filled with a nitrogen-IPA vapor.

Finally, at step 106, the liquid IPA supply tube 30 is then closed and the process tank 20 becomes completely filled with nitrogen. The entire time the nitrogen is filling the process tank 20, the slow drain valve 23 and large piston valves 39 are open and vacuum hole 16 located on the center lifter 12 is producing a vacuum force. At this point, the wafer substrates 7 are completely dry, including at every aspiration contact point 31, and are ready for removal from the process tank 20.

In another embodiment of the invention illustrated in FIG. 13, the need to use the object transporting member 1 is eliminated. A modified supporting member 32 is used. The modified supporting member 32 includes a bottom support tube 33 and two side support tubes 34.

Referring to FIG. 14, the bottom support tube 33 and the two side support tubes 34 have a plurality of teeth 35 along their surfaces that form slots in which a wafer substrate 7 can be slidably inserted and supported. A vacuum hole 16 is located between each pair of teeth 35 present on the bottom support tube 33 and the two side support tubes 34 of the modified supporting member 32.

Referring to FIG. 15, when a wafer substrate 7 is slidably inserted and supported by the modified supporting member 32 it contacts the modified supporting member 32 in exactly three aspiration contact points 31, one on each side support tube 34 and bottom support tube 33. Each aspiration contact point 31 on the modified supporting member 32 is located at or near a vacuum hole 16. Each vacuum hole 16 is an opening that leads to a vacuum passage 36. The vacuum passages 36 of the bottom support tube 33 and the two side support tubes 34 are fluidly connected to a flexible vacuum tube hole 37 (FIG. 13).

Referring to FIG. 16, in this embodiment of the invention, the modified supporting member 32 is not rigidly connected to the process tank 20. Instead, the modified supporting member 32 is capable of vertical movement. The modified supporting member 32 is fluidly connected to the vacuum system 21 by flexible vacuum tubing 38 that fluidly connects to the flexible vacuum tube hole 37. The flexible vacuum tubing 38 is constructed so that the modified supporting member 32 can be vertically raised above the top of the tank while remaining fluidly connected to the vacuum system 21 (FIG. 17).

FIG. 18, summarizes the steps of performing the claimed drying process with this embodiment of the invention. At step 200, the DI water supply valves 24 are opened and the process tank 20 is filled with DI water. At step 201, the tank lid 22 is removed, the modified supporting member 32 is positioned so that it is above the DI water level and protrudes from the top of the process tank 20, and at least one wafer substrate 7 is slidably inserted into the modified supporting member 32. Next at step 202, the modified supporting member 32 is lowered into the process tank 20 to a position where the wafer substrate 7 is fully submersed in the DI water and the tank lid 22 is put back on.

At step 203, the remaining volume of the sealed process tank 20 is filled with nitrogen and liquid IPA which enters the tank through the porous tube 28 which is supplied by the nitrogen supply tube 29 and liquid IPA supply tube 30 respectively. At step 204, the slow drain valve 23 is then opened and the vacuum system 21 is activated. Activating the vacuum system 21 creates a vacuum force at the vacuum holes 16 and sucks DI water into said vacuum holes 16. As the DI water drains from the tank, the nitrogen IPA vapor takes its place by occupying the volume of the process tank 20 previously occupied by the DI water.

At step 205, once the DI water level is just below the aspiration contact points 31 of the two side support tubes 34, the vacuum system 21 for those two aspiration contact points 31 is discontinued. The DI water in the process tank 20 continues to drain as a result of the slow drain valve 23 being open and the vacuum force being applied by the vacuum hole 16 at the aspiration contact point 31 of the bottom support tube 33. At step 206, when the DI water level gets to a level at or below the wafer substrates, large piston valves 39 are actuated to an open position thus quickly draining the remaining liquids. When the DI water is totally drained from the process tank 20, the process tank 20 is completely filled with a nitrogen-IPA vapor. At step 207, the liquid IPA supply tube 30 is then closed and the process tank 20 is completely filled with nitrogen. The entire time the nitrogen is filling the process tank 20, the slow drain valve 23 and large piston valves 39 are open and the vacuum hole 16 located on the bottom support tube 33 is producing a vacuum force. At this point, the wafer substrates 7 are completely dry, including at every aspiration contact point 31, and are ready for removal from the process tank 20.

What is claimed is:

1. A system for use in drying objects in a process tank comprising:
an object supporting member for supporting one or more objects, having at least one contact point for each object supported;
at least one aperture at or near each contact point; and
a source of negative pressure fluidly connected to each aperture.

2. The system of claim 1 wherein the object supporting member has three contact points for each object.

3. The system of claim 2 wherein the source of negative pressure comprises one or more vacuum or eductor pumps.

4. The system of claim 3 wherein the object supporting member is adapted to contact and support a plurality of objects during a drying process.

5. The system of claim 4 wherein the object supporting member is in a fixed position at or near the bottom of a process tank and the system further comprises an object transporting member.

6. The system of claim 5 wherein the object transporting member is a wafer basket so adapted to support a plurality of objects.

7. The system of claim 6 wherein the object supporting member has two outside lifters, a center lifter, and a base plate; the outside lifters and center lifter extending upward from the base plate; the center lifter being shorter than the two outside lifters; the outside lifters and center lifter being so positioned on the base plate so that the outside lifters and shorter center lifter can engage an object located in a wafer basket and remove the object from the wafer basket.

8. The system of claim 4 wherein the object supporting member is movable between a position at or near the bottom of the process tank and a loading position at or near the top of the process tank while remaining fluidly connected to the vacuum or eductor pumps.

9. The system of claim 8 wherein the object supporting member has two side support tubes and a bottom support tube; the two side support tubes and bottom support tube forming the three contact points for each object supported.

10. The system of claim 9 wherein the vacuum or eductor pumps are fluidly connected to each aperture by means of flexible vacuum tubing.

11. A method of drying one or more objects in a process tank having an object supporting member having at least one contact point for each object supported and an object transporting member comprising:
providing at least one aperture at or near each object contact point of the object supporting member and a source of negative pressure fluidly connected to each aperture;
filling the process tank with a liquid;
transferring the objects from the object transporting member to the object supporting member;
draining the liquid from the process tank so as to substantially dry the objects;
applying a vacuum force through the apertures so as to essentially remove trace amounts of liquid from each contact point; and
transferring the resultant fully dried object from the object supporting member to the object transporting member.

12. The method of claim 11 wherein the object supporting member has three object contact points for each object.

13. The method of claim 12 wherein the source of negative pressure comprises one or more vacuum or eductor pumps.

14. The method of claim 13 wherein the object transporting member is a wafer basket and the object is a wafer substrate.

15. The method of claim 14 wherein the wafer basket is adapted to transport a plurality of wafer substrates and the object supporting member is adapted to support the plurality of wafer substrates.

16. The method of claim 15 wherein the liquid is DI water.

17. The method of claim 16 wherein the object supporting member is in a fixed position at or near the bottom of the process tank, the object supporting member having two outside lifters, a center lifter, and a base plate; the outside lifters and center lifter extending upward from the base plate; the center lifter being shorter than the two outside lifters; the outside lifters and center lifter being so positioned on the base plate so that the outside lifters and shorter center lifter can engage the wafer substrates located in the wafer basket and remove the wafer substrates from the wafer basket.

18. The method of claim 17 wherein the wafer substrates are transferred from the wafer basket to the object supporting member by lowering the wafer basket into the process tank until the outside lifters and center lifter of the object supporting member engage, support, and remove the wafer substrates from the wafer basket; the outside lifters and center lifter forming the three contact points with each wafer substrate supported thereby.

19. The method of claim 18 further comprising:
sealing the process tank once the wafer substrates are transferred from the wafer basket to the object supporting member and are fully submersed in the DI water;
pumping nitrogen gas and liquid IPA into the process tank so that a nitrogen-IPA vapor forms in the process tank and fills the remaining volume of the process tank;
discontinuing the vacuum force being applied at the apertures of the two outside lifters when the level of the draining DI water is just below the apertures of the outside lifters;
discontinuing the flow of IPA liquid into the process tank when the DI water is fully drained from the process tank;
discontinuing the flow of nitrogen gas into the process tank;
discontinuing the vacuum force at the apertures of the center lifter; and
transferring the resultant fully dried wafer substrates from the object supporting member to the wafer basket by raising the wafer basket.

20. The method of claim 16 wherein the object supporting member has two side support tubes and a bottom support tube; the two side support tubes and bottom support tube forming the three contact points with the wafer substrates being supported thereby.

21. The method of claim 20 wherein the object supporting member moves between a position at or near the bottom of the process tank and a loading position at or near the top of the process tank, the wafer substrates being transferred from the active gripper to the object supporting member while the object supporting member is in the loading position, the object supporting member then returning the wafer substrates to the position at or near the bottom of the process tank after the process tank is filled with liquid.

22. The method of claim 21 wherein the vacuum or eductor pumps are fluidly connected to each aperture by means of flexible vacuum tubing.

23. The method of claim 22 further comprising:
sealing the process tank once the object supporting member is in the position at or near the bottom of the process tank;
pumping nitrogen gas and liquid IPA into the process tank so that a nitrogen-IPA vapor forms in the process tank and fills the remaining volume of the process tank,
discontinuing the vacuum force being applied at the apertures of the two side support tubes when the level of the draining DI water is just below the apertures of the two side support tubes;
discontinuing the flow of IPA liquid into the process tank when the DI water is fully drained from the process tank;
discontinuing the flow of nitrogen gas into the process tank;
discontinuing the vacuum force at the apertures of the bottom support tube; and
removing the resultant fully dried wafer substrates from the process tank by raising the object support member to the loading position; and
transferring the wafer substrates from the object supporting member to the active gripper.

24. A wafer substrate dried according to the process of claim 11.

25. A wafer substrate dried according to the process of claim 19.

26. A wafer substrate dried according to the process of claim 23.
